(19) United States
(12) Patent Application Publication
(10) Pub. No.: US 2003/0069158 A1
(43) Pub. Date: Apr. 10, 2003

(54) Fabric conditioning compositions

(75) Inventor: Stephen Mark Ilett, Merseyside (GB)

Correspondence Address: UNILEVER, PATENT DEPARTMENT, 45 RIVER ROAD, EDGEWATER, NJ, 07020, US

(73) Assignee: Unilever Home & Personal Care USA Division of Conopco, Inc.

(21) Appl. No.: 10/237,480

(22) Filed: Sep. 9, 2002

(30) Foreign Application Priority Data
Sep. 10, 2001 (GB) 0121803.1

(51) Int. Cl. C11D 3/00

(52) U.S. Cl. 510/329; 510/330; 510/504; 510/515

(57) ABSTRACT

A fabric conditioning composition comprises (a) from 7.5 to 80% by weight of a ester-linked quaternary ammonium fabric softening material comprising at least one mono-ester linked component and at least one tri-ester linked component, (b) an inorganic electrolyte and a (c) fatty complexing agent wherein the parent fatty acids or fatty acyl compounds from which component (a) is formed have an iodine value of from 0 to 4.

### FIELD OF THE INVENTION

The present invention relates to fabric conditioning compositions. More specifically, the invention relates to stable fabric-softening compositions comprising an ester-linked quaternary ammonium compound, a long chain fatty compound and an inorganic electrolyte.

### BACKGROUND OF THE INVENTION

It is well known to provide liquid fabric conditioning compositions, which soften in the rinse cycle.

Such compositions comprise less than 7.5% by weight of softening active, in which case the composition is defined as “dilute”, from 7.5% to about 30% by weight of active in which case the compositions are defined as “concentrated” or more than about 30% by weight of active, in which case the composition is defined as “super-concentrated”.

Concentrated and super-concentrated compositions are desirable since these require less packaging and are therefore environmentally more compatible than dilute or semi-dilute compositions.

A problem known to affect concentrated and super-concentrated fabric softening compositions is that the initial viscosity of a fully formulated composition can be very high, up to a point that the composition forms a gel or solid which is not dispersible or dispensable.

A further problem is that, upon storage, the product is not stable, especially when stored at high temperatures. Storage instability can manifest itself as a thickening of the product upon storage, again to the point that the product is no longer pourable.

The problem of thickening upon storage is particularly apparent in concentrated and superconcentrated fabric softening compositions comprising an ester-linked quaternary ammonium fabric softening material having one or more fully saturated alkyl chains.

It is believed that compositions comprising fully saturated quaternary ammonium fabric softeners form a lamellar gel structure. This structure is characterised by stacks of alternate bilayers of the quaternary ammonium material and water. In compositions comprising fully saturated softeners the bilayers are in a solid L_{β} state.

When the concentration of quaternary ammonium material increases, the liquid can become very thick or can even gel. It is believed that this high viscosity is due to the presence of the solid bilayers because the solid chains produce rigid droplets which occupy a larger volume hence trapping a larger amount of the external aqueous phase, and because the rigid particles deform less in flow.

This problem is typically not observed in compositions comprising unsaturated or partially saturated quaternary ammonium materials since the chains of the unsaturated softening materials are present in a more mobile state, known as the L_{α}-state. That is, the particles are less rigid occupying a smaller volume. As a consequence, fabric-conditioning compositions produced by using partially saturated or unsaturated actives show a lower viscosity for the same level of active as fully saturated ones. Another consequence of L_{α}-state softeners is the tendency for the compositions to be more stable in terms of long term viscosity than fully saturated softeners because the L_{α}-state particles have less tendency to aggregate.

Thus, the problems encountered with fully saturated softeners as identified above are not addressed in any way by compositions comprising partially saturated or fully unsaturated softening compounds.

Nevertheless, it is desirable to use ester-linked compounds due to their inherent biodegradability and to use substantially fully saturated quaternary ammonium fabric softening compounds due to their excellent softening capabilities and because they are more stable to oxidative degradation (which can lead to malodour generation) than partially saturated or fully unsaturated quaternary ammonium softening compounds.

Of the types of ester-linked quaternary ammonium materials known, it is desirable to use those based on triethanolamine which produce at least some mono-ester linked component and at least some tri-ester linked component since the raw material has a low melting temperature which enables the manufacturing process of the composition to occur at low temperatures. This reduces difficulties associated with high temperature handling, transport and processing of the raw material and compositions produced therefrom.

The problem of high initial viscosity and visco-stability upon storage has previously been addressed in various ways.

For instance, a first approach involves the reduction in the swelling of water layers (reduction in inter-lamellar spacing) of particles; a second approach involves the reduction in the size (number of layers) of each particle; and a third approach involves the combination of de-swelling and size reduction.

The first approach can be delivered by using electrolytes, polyelectrolytes and solvents. However, such compositions can suffer from colloidal stability problems since it is believed that the electrostatic charges which keep liposomes stable are shielded by the electrolyte.

The second approach can be achieved by attrition of the particles to smaller sizes by an input of energy such as milling or shearing. If the mechanical energy input (power/unit volume) is intense, bilayer ‘pieces’ or fragments may result. Fragments obtained mechanically may not be colloidally stable and can flocculate causing loss of fluidity. Also, milling or shearing products in a manufacturing process on an industrial scale is time consuming and expensive.

The third approach can be delivered by using micelle-forming surfactants to alter the intrinsic curvature of the quaternary ammonium fabric softening material and force it to form smaller particles—this acts as chemical energy input. The surfactants can simultaneously reduce the phase volume too. For instance, it is known to incorporate ethoxylated nonionic surfactants into fabric conditioning compositions for the purpose of stability. However, at high temperature it is often found that thickening of the composition is not prevented.

EP-A2-0415698 (Unilever) discloses the use of electrolytes, polyelectrolytes, or decoupling polymers to reduce the initial viscosity of fabric softening compositions.

DE 2503026 (Hoechst) discloses formulations comprising 3-12% of a softener (a mixture of non-ester quaternary ammonium compounds imidazoline group containing compounds), 1-6% of a cationic disinfectant, 0.1-5% of a lower alcohol, 0.5-5% of a fatty alcohol and 0-5% of a nonionic emulsifier.

WO 99/50378 (Unilever) relates to compositions comprising from 1 to 8% of a quaternary ammonium compound, a stabilising agent and a fatty alcohol. The fatty alcohol is present in order to thicken the dilute composition. The disclosure only relates to dilute compositions and so is not in any way directed to the problem addressed in the present invention of high temperature storage stability of concentrated compositions.

U.S. Pat. No. 4,844,823 (Colgate-Palmolive) discloses a composition comprising 3 to 20% by weight of the combination of a mixture of quaternary ammonium fabric softening compound and fatty alcohol in a weight ratio of from 6:1 to 2.8:1. Only non-ester quaternary ammonium compounds are exemplified and there is no disclosure or teaching of fully saturated quaternary ammonium compounds. The compositions optionally comprise salt and ethoxylated amines. The salt is suggested for further reduction in the initial viscosity and the ethoxylated amine for further storage stability. None of the examples comprises electrolyte. The viscosities are controlled by high-pressure homogenisation rather than by electrolyte. Indeed the prior art review in this document teaches that the use of electrolytes is unsatisfactory in concentrated fabric conditioning compositions because they offer the initial low viscosity but cause gellation or severe changes in viscosity on storage (over the temperature range of from 18 to 60° C.; the extremes at which fabric conditioners may be handled).

The prior art does not address nor give any suggestion how to overcome high initial viscosity and high temperature storage stability problems in concentrated compositions comprising fully hardened quaternary ammonium ester linked compounds based on triethanolamine.

WO 93/23510 (Procter & Gamble) mentions fatty alcohols and fatty acids as optional nonionic softeners and teaches that they can improve the fluidity of premix melts. There is no reference to reducing the viscosity of dispersions made from premix melts.

WO 98/49132, U.S. Pat. No. 4,213,867, U.S. Pat. No. 4,386,000, GB-A-2007734, DE 2503026, DE 3150179, U.S. Pat. No. 5,939,377, U.S. Pat. No. 9,391,5867 and U.S. Pat. No. 3,644,203 all disclose fabric conditioning compositions comprising fatty alcohols.

### OBJECTS OF THE INVENTION

The present invention seeks to address one or more of the above-mentioned problems, and, to give one or more of the above-mentioned benefits desired by consumers.

Surprisingly, the inventors have now found that, in the combined presence of an inorganic electrolyte and a fatty complexing agent, undesirably high viscosity of certain fabric conditioning compositions can not only be reduced but also long term storage stability can be achieved.

In particular, it has been found that by incorporating a fatty component which comprises a long alkyl chain, such as fatty alcohols or fatty acids (hereinafter referred to as “fatty complexing agents”) together with an inorganic electrolyte into softening compositions comprising a quaternary ammonium softening material having substantially fully saturated alkyl chains, at least some mono-ester linked component and at least some tri-ester linked component, the stability and initial viscosity of the composition can be dramatically improved.

### SUMMARY OF THE INVENTION

According to the present invention there is provided a fabric conditioning composition comprising:

(a) from 7.5 to 80% by weight of an ester-linked quaternary ammonium fabric softening material comprising at least some mono-ester linked component and at least some tri-ester linked component;

(b) a fatty complexing agent;

(c) an inorganic electrolyte.

wherein the parent fatty acids or fatty acyl compounds from which component (a) is formed have an iodine value of from 0 to 4.

There is also provided a method for treatment of fabrics comprising contacting the above-mentioned composition with fabrics in a laundry treatment process.

In the context of the present invention, the term “comprising” means “including” or “consisting of”. That is the steps, components, ingredients, or features to which the term “comprising” refers are not exhaustive.

### DETAILED DESCRIPTION OF THE INVENTION

The compositions of the present invention are preferably rinse conditioner compositions, more preferably aqueous rinse conditioner compositions for use in the rinse cycle of a domestic laundry process.

Quaternary Ammonium Fabric Softening Material

The fabric conditioning material used in the compositions of the present invention comprises one or more quaternary ammonium materials comprising a mixture of monoester linked, di-ester linked and tri-ester linked compounds.

By mono-, di- and tri-ester linked components, it is meant that the quaternary ammonium softening material comprises, respectively, a quaternary ammonium compound comprising a single ester-link with a fatty hydrocarbyl chain attached thereto, a quaternary ammonium compound comprising two ester-links each of which has a fatty hydrocarbyl chain attached thereto, and a quaternary ammonium compound comprising three ester-links each of which has a fatty hydrocarbyl chain attached thereto.

Below is shown typical levels of mono-, di- and tri-ester linked components in a fabric softening material used in the compositions of the invention.

| | % by weight of the raw |
|---|---|
| | material (TEA based softener |
| Component | with solvent) |
| Mono-ester | 10-30 |
| Di-ester | 30-60 |
| Tri-ester | 10-30 |
| Free fatty acid | 0.2-1.0 |
| Solvent | 10-20 |

The level of the mono-ester linked component of the quaternary ammonium material used in the compositions of the invention is preferably between 8 and 40% by weight, based on the total weight of the raw material in which the quaternary ammonium material is supplied.

The level of the tri-ester-linked component is preferably between 20 and 50% based on the total weight of the raw material in which the quaternary ammonium material is supplied.

The level of the tri-ester-linked component is preferably between 20 and 50% based on the total weight of quaternary ammonium material.

Preferably, the average chain length of the alkyl or alkenyl group is at least C₁₄, more preferably at least C₁₆. Most preferably at least half of the chains have a length of C₁₈.

It is generally preferred if the alkyl or alkenyl chains are predominantly linear.

The preferred ester-linked quaternary ammonium cationic softening material for use in the invention is represented by formula (I):

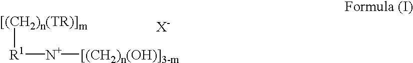

wherein each R is independently selected from a C₅₋₃₅ alkyl or alkenyl group, R¹ represents a C₁₋₄ alkyl or hydroxyalkyl group or a C₂₋₄ alkenyl group,

T is

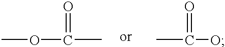

n is O or an integer selected from 1 to 4, m is 1, 2 or 3 and denotes the number of moieties to which it refers that pend directly from the N atom, and X is an anionic group, such as halides or alkyl sulphates, e.g. chloride, methyl sulphate or ethyl sulphate.

Especially preferred materials within this class are di-alkyl esters of triethanol ammonium methyl sulphate. A commercial example of a compound within this formula are Tetranyl® AHT-1 (di-hardened tallowyl ester of triethanol ammonium methyl sulphate 85% active).

Iodine Value of the Parent Fatty Acyl Group or Acid

The iodine value of the parent fatty acyl compound or acid from which the quaternary ammonium fabric softening material is formed is from 0 to 4, preferably from 0 to 3, more preferably from 0 to 2. Most preferably the iodine value of the parent fatty acid or acyl group from which the quaternary ammonium fabric softening material is formed is from 0 to 1. That is, it is preferred that the alkyl or alkenyl chains are substantially fully saturated.

If there is any unsaturated quaternary ammonium fabric softening material present in the composition, the iodine value, referred to above, represents the mean iodine value of the parent fatty acyl compounds or fatty acids of all of the quaternary ammonium materials present.

In the context of the present invention, iodine value of the parent fatty acyl compound or acid from which the fabric softening material formed, is defined as the number of grams of iodine which react with 100 grams of the compound.

In the context of the present invention, the method for calculating the iodine value of a parent fatty acyl compound/acid comprises dissolving a prescribed amount (from 0.1-3 g) into about 15 ml chloroform. The dissolved parent fatty acyl compound/fatty acid is then reacted with 25 ml of iodine monochloride in acetic acid solution (0.1M). To this, 20 ml of 10% potassium iodide solution and about 150-ml deionised water is added. After addition of the halogen has taken place, the excess of iodine monochloride is determined by titration with sodium thiosulphate solution (0.1M) in the presence of a blue starch indicator powder. At the same time a blank is determined with the same quantity of reagents and under the same conditions. The difference between the volume of sodium thiosulphate used in the blank and that used in the reaction with the parent fatty acyl compound or fatty acid enables the iodine value to be calculated.

The quaternary ammonium fabric softening material of formula (I) is present in an amount from about 7.5 to 80% by weight of quaternary ammonium material (active ingredient) based on the total weight of the composition, more preferably 10 to 60% by weight, most preferably 11 to 40% by weight, e.g. 12.5-25% by weight.

Excluded Quaternary Ammonium Compounds

Quaternary ammonium fabric softening materials which are free of ester linkages or, if ester-linked, do not comprise at least some mono-ester component and some tri-ester component are excluded from the scope of the present invention. For instance, quaternary ammonium compounds having the following formulae are excluded:

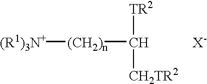

wherein R¹, R², T, n and X⁻ are as defined above; and

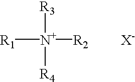

where R₁ to R₄ are not interrupted by ester-links, R₁ and R₂ are C₈₋₂₈ alkyl or alkenyl groups; R₃ and R₄ are C₁₋₄ alkyl or C₂₋₄ alkenyl groups and X⁻ is as defined above.

Inorganic Electrolyte

The inorganic electrolyte may comprise a univalent or a multivalent anion. Preferably, the multivalent anion is divalent. Sulphate is particularly preferred. The counter ion is preferably an alkaline earth metal, ammonium or alkali metal. Preferably, it comprises an alkali metal cation or ammonium. Typically preferred are sodium, potassium, calcium, magnesium or ammonium salts. There may be more than one salt of a multivalent anion present, and they may differ in the choice of anion, cation or both. Sodium sulphate is particularly preferred.

Salts of organic sequestering anions, such as ethylene diamine disuccinate are not suitable.

The total quantity of salt of multivalent anion is suitably in the range 0.001-2.0, more preferably 0.02-1.5%, most preferably 0.1-1.2%, e.g. 0.2-1.0% by weight, based on the total weight of the composition.

It is preferred that the salt of the multivalent anion is substantially water soluble. Preferably, the salt of the multivalent anion has a solubility in excess of 1 gram per litre, preferably in excess of 25 grams per litre.

It is preferred that the salt of the univalent anion comprises an alkali metal or alkaline earth metal salt. It is particularly preferred that the cation is sodium, potassium, calcium, magnesium or ammonium. The univalent anion may be any suitable univalent anion. It is preferably a halide, most preferably chloride. There may be more than one salt of a univalent anion present. They may differ in the choice of anion, cation, or both. Particularly preferred are calcium chloride, magnesium chloride, sodium chloride, ammonium halide, rare earth halides, such as lanthanum chloride and alkali metal salts of organic acids such as sodium acetate and sodium benzoate.

The total quantity of salt of univalent anion is suitably in the range 0.005-2.0%, more preferably 0.01-1.5%, most preferably 0.1-1.2%, e.g. 0.2 to 1.0% by weight, based on the total weight of the composition.

A particularly preferred combination comprises a mixture of sodium sulphate with an electrolyte selected from the group consisting of sodium chloride, calcium chloride, magnesium chloride, potassium chloride and ammonium chloride.

Preferably, the total weight of salts of univalent and multivalent anions is in the range 0.5-3.0%, more preferably 1.0-2.0%, more preferably 1.0-1.5% by weight, based on the total weight of the composition.

The weight ratio of salt of univalent anion to salt of multivalent anion is suitably in the range 10:1 to 1:10, more preferably 5:1 to 1:5, most preferably 3:1 to 1:3.

Preferably, the total weight of inorganic electrolyte present in the composition is in the range from 0.1-3.0%, more preferably 0.2-2.0%, more preferably 0.5-1.5% by weight, based on the total weight of the composition.

The salt of the univalent anion must be substantially water soluble. Preferably, it has a solubility in excess of 1 gram per litre, more preferably in excess of 20 grams per litre.

Fatty Complexing Agent

The compositions of the present invention comprise a fatty complexing agent.

Without being bound by theory it is believed that the fatty complexing material improves the viscosity profile of the composition by complexing with mono-ester component of the fabric softening material thereby providing a composition which has relatively higher levels of di-ester linked and tri-ester linked components. The di-ester and tri-ester linked components are more stable and do not affect initial viscosity as detrimentally as the mono-ester component. Therefore, compositions already free of the mono- and tri-ester linked components do not fall within the scope of the invention.

The applicants also believe that that the complexing of the mono-ester linked component (which does not contribute to softening) with the fatty complexing material thereby provides a material which does contribute to softening.

Especially suitable fatty complexing agents include fatty alcohols and fatty acids. Of these, fatty alcohols are most preferred.

Preferred fatty acids include hardened tallow fatty acid (available under the tradename Pristerene, ex Uniqema).

Preferred fatty alcohols include hardened tallow alcohol (available under the tradenames Stenol and Hydrenol, ex Cognis and Laurex CS, ex Albright and Wilson) and behenyl alcohol, a C22 chain alcohol, available as Lanette 22 (ex Henkel).

The fatty complexing agent is present in an amount from 0.01% to 15% by weight based on the total weight of the composition. More preferably, the fatty component is present in an amount of from 0.5 to 10%, most preferably from greater than 1.5% to 5%, e.g. 1.6 to 4% by weight, based on the total weight of the composition.

The weight ratio of the mono-ester component of the quaternary ammonium fabric softening material to the fatty complexing agent is preferably from 5:1 to 1:5, more preferably 4:1 to 1:4, most preferably 3:1 to 1:3, e.g. 2:1 to 1:2.

Without wishing to be bound by theory, the inventors believe that the stabilisation of viscosity of fabric conditioners even in the presence of the electrolyte, which is known to destabilise fabric conditioning compositions, is due to the fatty complexing agent increasing the level of counter-ion dissociation and hence increasing electrostatic repulsion between liposomal particles such that partial shielding with an electrolyte is not detrimental to stability.

Calculation of Mono-Ester Linked Component of the Quaternary Ammonium Material

The quantitative analysis of mono-ester linked component of the quaternary ammonium material is carried out through the use of Quantitative ¹³C NMR spectroscopy with inverse gated ¹H decoupling scheme.

The sample of known mass of the quaternary ammonium raw material is first dissolved in a known volume of CDCl₃ along with a known amount of an assay material such as naphthalene. A ¹³C NMR spectrum of this solution is then recorded using both an inverse gated decoupling scheme and a relaxation agent. The inverse gated decoupling scheme is used to ensure that any Overhauser effects are suppressed whilst the relaxation agent is used to ensure that the negative consequences of the long t₁ relaxation times are overcome (i.e. adequate signal-to-noise can be achieved in a reasonable timescale).

The signal intensities of characteristic peaks of both the carbon atoms in the quaternary ammonium material and the naphthalene are used to calculate the concentration of the mono-ester linked component of the quaternary ammonium material. In the quaternary ammonium material, the signal represents the carbon of the nitrogen-methyl group on the quaternary ammonium head group. The chemical shift of the nitrogen-methyl group varies slightly due to the different degree of esterification; characteristic chemical shifts for the mono-, di- and tri-ester links are 48.28, 47.97 and 47.76 ppm respectively. Any of the peaks due to the napthalene carbons that are free of interference from other components can then be used to calculate the mass of mono-ester linked component present in the sample as follows:

Mass_{MQ}(mg/ml)=(mass_{Naph}×I_{MQ}×N_{Naph}×M_{MQ})/(I_{Naph}×N_{MQ}×M_{Naph})

where Mass_{MQ}=mass mono-ester linked quaternary ammonium material in mg/ml, mass_{Naph}=mass naphthalene in mg/ml, I=peak intensity, N=number of contributing nuclei and M=relative molecular mass. The relative molecular mass of naphthalene used is 128.17 and the relative molecular mass of the mono-ester linked component of the quaternary ammonium material is taken as 526.

The weight percentage of mono-ester linked quaternary ammonium material in the raw material can thus be calculated:

% of mono-ester linked quaternary ammonium material in the raw material=(mass_{MQ}/mass_{HT-TEA})×100

where mass_{HT-TEA}=mass of the quaternary ammonium material and both mass_{MQ} and mass_{HT-TEA} are expressed as mg/ml.

For a discussion of the NMR technique, see “100 and More Basic NMR Experiments”, S Braun, H-O Kalinowski, S Berger, 1^{st} edition, pages 234-236.

Nonionic Surfactant

It is preferred that the compositions further comprise a nonionic surfactant. Typically these can be included for the purpose of stabilising the compositions.

Suitable nonionic surfactants include addition products of ethylene oxide and/or propylene oxide with fatty alcohols, fatty acids and fatty amines.

Any of the alkoxylated materials of the particular type described hereinafter can be used as the nonionic surfactant.

Suitable surfactants are substantially water soluble surfactants of the general formula:

R—Y—(C₂H₄O)_{z}—C₂H₄OH

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the ethoxylated nonionic surfactant, Y is typically:

—O—,—C(O)O—,—C(O)N(R)— or —C(O)N(R)R—

in which R has the meaning given above or can be hydrogen; and Z is at least about 8, preferably at least about 10 or 11.

Preferably the nonionic surfactant has an HLB of from about 7 to about 20, more preferably from 10 to 18, e.g. 12 to 16.

Examples of nonionic surfactants follow. In the examples, the integer defines the number of ethoxy (EO) groups in the molecule.

A. Straight-Chain, Primary Alcohol Alkoxylates

The deca-, undeca-, dodeca-, tetradeca-, and pentadecaethoxylates of n-hexadecanol, and n-octadecanol having an HLB within the range recited herein are useful viscosity/dispersibility modifiers in the context of this invention. Exemplary ethoxylated primary alcohols useful herein as the viscosity/dispersibility modifiers of the compositions are C₁₈ EO(10); and C₁₈ EO(11). The ethoxylates of mixed natural or synthetic alcohols in the “tallow” chain length range are also useful herein. Specific examples of such materials include tallow alcohol-EO(11), tallow alcohol-EO(18), and tallow alcohol-EO (25), coco alcohol-EO(10), coco alcohol-EO(15), coco alcohol-EO(20) and coco alcohol-EO(25).

B. Straight-Chain, Secondary Alcohol Alkoxylates

The deca-, undeca-, dodeca-, tetradeca-, pentadeca-, octadeca-, and nonadeca-ethoxylates of 3-hexadecanol, 2-octadecanol, 4-eicosanol, and 5-eicosanol having an HLB within the range recited herein are useful viscosity and/or dispersibility modifiers in the context of this invention. Exemplary ethoxylated secondary alcohols useful herein as the viscosity and/or dispersibility modifiers of the compositions are: C₁₆ EO(11); C₂₀ EO(11); and C₁₆ EO(14).

C. Alkyl Phenol Alkoxylates

As in the case of the alcohol alkoxylates, the hexa- to octadeca-ethoxylates of alkylated phenols, particularly monohydric alkylphenols, having an HLB within the range recited herein are useful as the viscosity and/or dispersibility modifiers of the instant compositions. The hexa- to octadeca-ethoxylates of p-tri-decylphenol, m-pentadecylphenol, and the like, are useful herein. Exemplary ethoxylated alkylphenols useful as the viscosity and/or dispersibility modifiers of the mixtures herein are: p-tridecylphenol EO(11) and p-pentadecylphenol EO(18).

As used herein and as generally recognised in the art, a phenylene group in the nonionic formula is the equivalent of an alkylene group containing from 2 to 4 carbon atoms. For present purposes, nonionics containing a phenylene group are considered to contain an equivalent number of carbon atoms calculated as the sum of the carbon atoms in the alkyl group plus about 3.3 carbon atoms for each phenylene group.

D. Olefinic Alkoxylates

The alkenyl alcohols, both primary and secondary, and alkenyl phenols corresponding to those disclosed immediately hereinabove can be ethoxylated to an HLB within the range recited herein and used as the viscosity and/or dispersibility modifiers of the instant compositions.

E. Branched Chain Alkoxylates

Branched chain primary and secondary alcohols which are available from the well-known “OXO” process can be ethoxylated and employed as the viscosity and/or dispersibility modifiers of compositions herein.

F. Polyol Based Surfactants

Suitable polyol based surfactants include sucrose esters such sucrose mono-oleates, alkyl polyglucosides such as stearyl monoglucosides and stearyl triglucoside and alkyl polyglycerols.

The above nonionic surfactants are useful in the present compositions alone or in combination, and the term “nonionic surfactant” encompasses mixed nonionic surface-active agents.

Preferably the nonionic surfactant is present in an amount from 0.01 to 10%, more preferably 0.1 to 5%, most preferably 0.35 to 3.5%, e.g. 0.5 to 2% by weight, based on the total weight of the composition.

Perfume

The compositions of the invention preferably comprise one or more perfumes.

It is well known that perfume is provided as a mixture of various components.

It is preferred that at least a quarter (by weight) or more, preferably a half or more of the perfume components have a ClogP of 2.0 or more, more preferably 3.0 or more, most preferably 4.5 or more, e.g. 10 or more.

Suitable perfumes having a ClogP of 3 or more are disclosed in U.S. Pat. No. 5,500,137.

The hydrophobicity of the perfume and oily perfume carrier are measured by ClogP. ClogP is calculated using the “ClogP” program (calculation of hydrophobicities as logp (oil/water)) version 4.01, available from Daylight Chemical Information Systems Inc of Irvine Calif., USA.

The perfume is preferably present in an amount from 0.01 to 10% by weight, more preferably 0.05 to 5% by weight, most preferably 0.5 to 4.0% by weight, based on the total weight of the composition.

Liquid Carrier

The liquid carrier employed in the instant compositions is preferably water due to its low cost relative availability, safety, and environmental compatibility. The level of water in the liquid carrier is more than about 50%, preferably more than about 80%, more preferably more than about 85%, by weight of the carrier. The level of liquid carrier is greater than about 50%, preferably greater than about 65%, more preferably greater than about 70%. Mixtures of water and a low molecular weight, e.g. <100, organic solvent, e.g. a lower alcohol such as ethanol, propanol, isopropanol or butanol are useful as the carrier liquid. Low molecular weight alcohols including monohydric, dihydric (glycol, etc.) trihydric (glycerol, etc.), and polyhydric (polyols) alcohols are also suitable carriers for use in the compositions of the present invention.

Co-Active Softeners

Co-active softeners for the cationic surfactant may also be incorporated in an amount from 0.01 to 20% by weight, more preferably 0.05 to 10%, based on the total weight of the composition. Preferred co-active softeners include fatty esters, and fatty N-oxides.

Preferred fatty esters include fatty monoesters, such as glycerol monostearate. If GMS is present, then it is preferred that the level of GMS in the composition, is from 0.01 to 10 wt %, based on the total weight of the composition.

The co-active softener may also comprise an oily sugar derivative. Suitable oily sugar derivatives, their methods of manufacture and their preferred amounts are described in WO-A1-01/46361 on page 5 line 16 to page 11 line 20, the disclosure of which is incorporated herein.

Polymeric Viscosity Control Agents

It is useful, though not essential, if the compositions comprise one or more polymeric viscosity control agents. Suitable polymeric polymeric viscosity control agents include nonionic and cationic polymers, such as hydrophobically modified cellulose ethers (e.g. Natrosol Plus, ex Hercules), cationically modified starches (e.g. Softgel BDA and Softgel BD, both ex Avebe). A particularly preferred viscosity control agent is a copolymer of methacrylate and cationic acrylamide available under the tradename Flosoft 200 (ex SNF Floerger).

Nonionic and/or cationic polymers are preferably present in an amount of 0.01 to 5 wt %, more preferably 0.02 to 4 wt %, based on the total weight of the composition.

Further Optional Ingredients

Other optional nonionic softeners, bactericides, soil-releases agents may also be incorporated in the compositions of the invention.

The compositions may also contain one or more optional ingredients conventionally included in fabric conditioning compositions such as pH buffering agents, perfume carriers, fluorescers, colourants, hydrotropes, antifoaming agents, antiredeposition agents, enzymes, optical brightening agents, anti-shrinking agents, anti-wrinkle agents, anti-spotting agents, antioxidants, sunscreens, anti-corrosion agents, drape imparting agents, anti-static agents, ironing aids and dyes.

Product Form

In its undiluted state at ambient temperature the product comprises an aqueous liquid.

The compositions are preferably aqueous dispersions of the quaternary ammonium softening material.

Product Use

The composition is preferably used in the rinse cycle of a home textile laundering operation, where, it may be added directly in an undiluted state to a washing machine, e.g. through a dispenser drawer or, for a top-loading washing machine, directly into the drum. Alternatively, it can be diluted prior to use. The compositions may also be used in a domestic hand-washing laundry operation.

It is also possible, though less desirable, for the compositions of the present invention to be used in industrial laundry operations, e.g. as a finishing agent for softening new clothes prior to sale to consumers.

Preparation

The compositions of the invention may be prepared according to any suitable method.

In a first preferred method, water is heated in a vessel. The quaternary ammonium material and fatty complexing agent are co-melted in a separate vessel and added to water, while stirring, at a temperature above the melting temperature of the quaternary ammonium material. Perfume is then added to the vessel. The mixture is then allowed to cool to room temperature and the inorganic electrolyte, and optional minor ingredients are added with stirring if necessary. In an alternative method, the perfume can be added to the mixture after the co-melt is formed, e.g. at any time during the cooling stage.

### EXAMPLES

The invention will now be illustrated by the following non-limiting examples. Further modifications will be apparent to the person skilled in the art.

Samples of the invention are represented by a number. Comparative samples are represented by a letter.

All values are % by weight of the active ingredient unless stated otherwise.

### Example 1

A comparison of the viscostability of compositions comprising unsaturated and saturated cationic softening compounds was made.

The following compositions were prepared:

TABLE 1

| | Sample A | Sample B |
|---|---|---|
| Quat A | 13 | 0 |
| Quat B | 0 | 13 |
| Perfume | 0.96 | 0.96 |
| Antifoam | 0.03 | — |
| Preservative | 0.08 | 0 |
| Dye | 0.0015 | 0.0015 |
| CaCl2 | 0 | 0 |
| MgCl2 | 0 | 0 |
| Water | To 100 | To 100 |

Quat A is Stepantex VA9O (ex Stepan). A partially saturated tallowyl ester of TEA with methyl sulphate counter-ion provided as 90% active in 10% isopropyl alcohol (IPA). The iodine value of the parent fatty acid of the quaternary ammonium material is substantially greater than 4.
Quat B is Tetranyl AHT-1 (ex Kao). A fully hardened tallowyl ester of TEA with methyl sulphate (provided as 85% active in 15% IPA). The iodine value of the parent fatty acid of the quaternary ammonium material is less than 1.
Sample A was prepared by heating the quaternary ammonium material and water to a temperature above the melting point of the quaternary ammonium material and then mixing the ingredients together. The mixture was cooled to room temperature and then perfume was added. The minor ingredients were then added with stirring if necessary.
Sample B was prepared by heating the quaternary ammonium material and water to a temperature above the melting point of the quat and then mixing the ingredients together. Perfume was added and the mixtrure was then allowed to cool.

The minor ingredients were then added with stirring if necessary.

The visco-stability of the compositions based on unsaturated and saturated quaternary ammonium species was compared. The results are in table 2 below.

TABLE 2

| Viscosity | Sample A | Sample B |
|---|---|---|
| Initial at 25° C. | 233 | 2550 |
| 4 weeks at 4° C. | 110 | 1190 |
| 4 weeks at 25° C. | 210 | 965 |
| 4 weeks at 37° C. | 210 | 1410 |
| 4 weeks at 41° C. | Not measured | gel |

Viscosity was measured at 25° C. at 25 s⁻¹ using a Haake RV20 Rotoviscometer NV cup and bob.

The results demonstrate that the problem of undesirably high viscosity both initially and upon storage is very apparent when the composition is based on a saturated quaternary ammonium material but is not present when the composition is based on an unsaturated quaternary ammonium material.

### Example 2

The following compositions were prepared:

TABLE 3

| | Sample C | Sample 1 | Sample 2 |
|---|---|---|---|
| Quat B | 11.09 | 11.09 | 11.09 |
| Fatty alcohol | 1.89 | 1.89 | 1.89 |
| Perfume | 0.95 | 0.95 | 0.95 |
| Antifoam | 0.03 | 0.03 | 0.03 |
| Preservative | 0.08 | 0.08 | 0.08 |
| Dye | 0.0015 | 0.0015 | 0.0015 |
| MgCl₂ | 0 | 0.1 | 0.05 |
| Water | To 100 | To 100 | To 100 |

Quat B is defined above
The fatty alcohol is Laurex CS (ex Albright and Wilson)
The MgCl₂ was provided as a 10% aqueous solution.

The samples were prepared by co-melting the quaternary ammonium material, the fatty complexing agent and adding to water at a temperature above the melting temperature of the quaternary ammonium material. Perfume was then added to the vessel. The mixture was then allowed to cool to room temperature and salt (if present), and minor ingredients were added with stirring if necessary.

The visco-stability results are given in the following table.

TABLE 4

| Viscosity | Sample C | Sample 1 | Sample 2 |
|---|---|---|---|
| Initial at 25° C. | 477 | 199 | 182 |
| 4 weeks at 25° C. | 228 | 184 | 150 |
| 4 weeks at 37° C. | 425 | 204 | 144 |
| 4 weeks at 41° C. | 490 | 195 | Not measured |
| 4 weeks at 45° C. | Not measured | Not measured | 160 |

Viscosity was measured at 25° C. at 25 s⁻¹ using a Haake RV20 Rotoviscometer NV cup and bob.

The results demonstrate that not only does the presence of the electrolyte in the compositions reduce initial viscosity but significantly further reduces the viscosity over the long term during high (37° C. and above) and room temperature (25° C.) storage.

This result is particularly surprising since it is known that the presence of an electrolyte often destabilises fabric conditioning compositions when they are stored under high and room temperature conditions.

1. A fabric conditioning composition comprising:
(a) from 7.5 to 80% by weight of a ester-linked quaternary ammonium fabric softening material comprising at least one mono-ester linked component and at least one tri-ester linked component;
(b) an inorganic electrolyte
(c) a fatty complexing agent
wherein the parent fatty acids or fatty acyl compounds from which component (a) is formed have an iodine value from 0 to 4.

2. A composition as claimed in claim 1, in which the electrolyte comprises a halide of an alkaline earth metal or an alkali metal.

3. A composition as claimed in claim 1 wherein the electrolyte is present in an amount from 0.1-3.0% by weight, based on the total weight of the composition.

4. A composition as claimed in claim 1 in which the weight ratio of mono-ester linked component of material (a) to fatty complexing agent (c) is from 5:1 to 1:5.

5. A composition as claimed in claim 1 wherein the quaternary ammonium material is represented by formula (I): 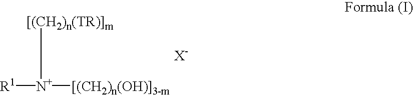
wherein each R is independently selected from a C₅₋₃₅ alkyl or alkenyl group, R¹ represents a C₁₋₄ alkyl or hydroxyalkyl group or a C₂₋₄ alkenyl group,
T is 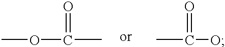
n is O or an integer selected from 1 to 4, m is 1, 2 or 3 and denotes the number of moieties to which it refers that pend directly from the N atom, and X is an anionic group, such as halides or alkyl sulphates, e.g. chloride, methyl sulphate or ethyl sulphate.

6. A composition as claimed in claim 1, further comprising an oily sugar derivative.

7. A method for treatment of fabrics comprising contacting the composition as claimed in claim 1 with fabrics in a laundry treatment process.

8. A method of stabilising the viscosity of a fabric conditioning composition comprising a quaternary ammonium softening material formed from a parent fatty acid or parent fatty acyl compound having an iodine value of from 0 to 5 comprising the steps of
(a) mixing the quaternary ammonium material, a fatty complexing agent and water at a temperature above the melting point of the quaternary ammonium material;
(b) allowing the mixture to cool to 40° C. or less and
(c) adding an inorganic electrolyte to the mixture.
